(19) United States
(12) Patent Application Publication
(10) Pub. No.: US 2026/0167885 A1
(43) Pub. Date: Jun. 18, 2026

(54) AMIDE DERIVATIVES FOR INHIBITING CORROSION IN SOUR AND SWEET MEDIA IN PETROLEUM REFINERY STREAMS AND THEIR OBTAINING PROCESS

(71) Applicant: Instituto Mexicano del Petróleo, Mexico City (MX)

(72) Inventors: Araceli Vega Paz, Mexico City (MX); Diego Javier Guzmán Lucero, Mexico City (MX); Mercedes Bazaldua Domínguez, Mexico City (MX); Silvia Castillo Acosta, Mexico City (MX); Javier Guzmán Pantoja, Mexico City (MX); Natalya Victorovna Likhanova, Mexico City (MX); Felipe de Jesús Guevara Rodríguez, Mexico City (MX); Mariana Zavala López, Mexico City (MX); Joel Ramírez Salgado, Mexico City (MX)

(21) Appl. No.: 19/406,350

(22) Filed: Dec. 2, 2025

(30) Foreign Application Priority Data
Dec. 13, 2024 (MX) MX/A/2024/015527

(51) Int. Cl. C10L 10/04; C10L 1/224

(52) U.S. Cl. CPC C10L 10/04; C10L 1/224; C10L 2230/08; C10L 2300/20

(57) ABSTRACT

Disclosed are internal corrosion inhibitors for crude oil refining processes, where the water content is associated with different concentrations of inorganic salts and where there is evidence of the presence of dissolved H₂S and/or CO₂. The corrosion inhibitors mitigate corrosion in refinery environments due to the chemical structure of the components derived from amino acids and benzaldehydes, with characteristics that tolerate corrosive environments. The products comprise two or more members of these inhibitors along with a solvent. Their action is to reduce the corrosion of metal surfaces inside refineries that process crude oil with water containing dissolved ionic species, capable of damaging metal structures. The combination of two or more different components produces a synergistic effect, which is attributed to interactions with the metal surface, each other, or with the corrosive medium, depending on the length of the molecular chain. This allows corrosion inhibition with a reduced formulation dose.

### CROSS-REFERENCE TO RELATED APPLICATIONS

This patent application claims priority under 35 U.S.C. Section 119 to Mexican Patent Application No. MX/a/2024/015527, filed Dec. 13, 2024, the entire disclosure of which is incorporated herein by reference.

### FIELD

The present disclosure relates to the synthesis and use of amides derived from amino acids and benzaldehydes as corrosion inhibitors of steel and admiralty alloys in sweet and sour media ranging from acidic to basic pH using dosages below 100 ppm and temperatures up to 60° C. These conditions are common in streams from refineries in the petroleum industry.

### BACKGROUND

Corrosion of metal surfaces in the oil industry occurs in production and refining areas; in pipelines, equipment, pipes, crude distillation processes, catalytic plants (FCC), hydroprocessing, catalytic reforming, and boilers, among others. When this happens, the equipment must be replaced or refurbished. Corrosion problems are complex due to the different corrosion mechanisms that depend on H₂S, CO₂, H₂S/CO₂, naphthenic acids, and erosion [1].

To slow down the corrosion rate, it is advisable to use substances that minimize the transfer of electrons between the cathodic and anodic areas of the material. For this purpose, organic corrosion inhibitors are widely used because they are relatively inexpensive and easy to apply.

Organic corrosion inhibitors are compounds containing polar groups, such as nitrogen, oxygen, sulfur, or phosphorus, which can interact with the metal surface through physical or chemical adsorption and form a thin film that reduces the corrosion rate by blocking the access of corrosive agents to the metal surface [2]. These can be classified into different types according to their chemical nature, action mechanism, and application.

The functionality of a corrosion inhibitor in a corrosive environment depends on several factors, such as metal type, nature of the corrosive environment, inhibitor concentration, temperature, pH, and additional petroleum additives. The corrosion inhibition mechanism can be studied using different methods, such as electrochemical techniques, metal surface analysis, and corrosion tests [3].

Organic corrosion inhibitors are a good alternative for mitigating corrosion. Among the organic compounds used for this purpose, the most notable are amino acid derivatives, benzaldehyde derivatives, benzotriazoles/azoles, and synthetic polymers.

### Amino Acid Derivatives:

Amino acids are effective corrosion inhibitors with low toxicity, which allows them to be used in different corrosive environments, increasing their efficiency with higher pH [4].

In this context, the European patent ES2897710T3 mentions the use of amino acids as part of bifunctional anti-deposit and anti-corrosion additives applied in the oil industry during the hydrocarbon extraction process [5]. Meanwhile, patent LU101645B1 points to the application of the amino acids glycine and arginine, as well as aminocaproic acid, to protect metal surfaces made of steel, aluminum, and magnesium [6].

In the scientific literature on the use of amino acids as corrosion inhibitors for different steel and copper alloys [7], [8], [9], [10], B. El Ibrahimi et al. are identified with studies on the subject, mainly for acidic media, proposing the use of amino acids and their derivatives as a “green” alternative to existing corrosion inhibitors [11], [12]. The results with alanine, cysteine, and S-methylcysteine amino acids evaluated as corrosion inhibitors in 1M HCl conclude that alanine acts as a cathodic inhibitor, and cysteine and S-methylcysteine derivatives work as mixed-type inhibitors [13]. Based on theoretical studies with various amino acids, it was concluded that cysteine [14], [15], lysine [16], arginine [17], [18], glutamine, and asparagine [19], [20], [21] were the most promising compounds for inhibiting corrosion. Glutamic acid derivatives have shown to be effective inhibitors of metal corrosion in an acidic solution; therefore, recent research in the use of amino acids as corrosion inhibitors has been focused on synthesizing derivatives of these compounds with high corrosion inhibition efficiency [4].

The incorporation of triazolyl rings into the amino acid structure enhances the anticorrosive activity for steel in HCl media [22], while imidazole-type heterocycles improve anticorrosive properties in saline [23] and acidic [24] media.

There are several studies on the use of amino acid-based Schiff bases as corrosion inhibitors of carbon steel in a 3.5% NaCl solution saturated with CO₂ at 50° C. [25], [26]. In an alkaline medium of 0.5 M NaOH and in the presence of NaCl salt, sodium dodecyltryptophan showed better results than sodium dodecylhistidine and sodium dodecylasparagine [27].

In this regard, the Mexican patent MXPA04011376A from the Mexican Petroleum Institute points to the class of organic compounds, derivatives of N-methylenearyl alkylamides substituted from amino acids, to control corrosion of steel in acidic media [28].

For steel in 1M HCl medium, the amino acid derivatives leucine, phenylalanine, and methionine [29], [30] have shown high inhibition efficiency, especially phenylalanine derivatives: with oleic acid and polyethylene glycol [31], phenylalanine saccharinate [32]; phenylalanine 2-oxoindoline [33], and phenylalanine-substituted benzimidazole [34].

However, when reviewing the scientific literature on this subject, no studies were found related to the preparation and use of benzyl-phenylalanine derivatives as corrosion inhibitors in refining processes.

### Benzaldehyde-Derived Amides:

Various corrosion inhibitor compositions have been described in the petroleum industry. In one of them (MXPA/A/1999/006324), a salt produced by the neutralization reaction of an acylated polyamine and a phosphate ester was used together with paraffinic and aromatic hydrocarbons; however, the concentrations at which they were applied were greater than 100 ppm; the formulation was applied in cases of corrosion by naphthenic acids [35]. Patents MXPA/A/2000/012283 [36] and MXPA/A/2000/010389 [37] highlight the use of ethoxylated polyamide based on reactions with polyamines and a fatty acid or imidazoline as products that inhibit corrosion in gas sweetening units, while MXPA/A/2004/011376 mentions substituted alkylamide/methylenearyl derivatives of amino acids to control corrosion in hydrocarbon refining and transportation systems [38]. Similarly, patent MXPA/A/2005/011348 presents a macrocyclic tetramide-di-N-methyl ester product for controlling corrosion in acidic environments [39].

In the field of corrosion inhibitors for pipelines transporting sour media, patent MX360194 stands out, mentioning the use of a saturated anhydride and unsaturated carboxylic acid amide [40]. On the other hand, Nalco developed a 1-methylpiperazine-based inhibitor (U.S. Pat. No. 7,989,403B2) [41], and Kechuang presented a water-soluble composition with imidazolinamide for the oil refining industry (CN101705112A) [42].

In the field of oil reservoirs, Stepan offers the product AR113004, which includes a corrosion inhibitor based on quaternary ammonium, phosphate esters, amines, amides, and imidazoline [43], while Clariant presents AR110296, an inhibitor that combines biodegradable sugar amide surfactants with at least one sulfur-based synergistic agent [44]. In addition, a composition described in U.S. Pat. No. 5,854,180 stands out, designed to inhibit corrosion caused by hydrochloric acid solutions in the acidification of oil wells, incorporating components such as cinnamaldehyde, ethylene glycol, and ethoxylated alcohols [45].

During the review of works related to the preparation and application of benzaldehyde-derived amide molecules as corrosion inhibitors in refining processes, such structures were not identified.

### SUMMARY

This summary is intended to introduce the subject matter of the present disclosure, but does not cover each and every embodiment, combination, or variation that is contemplated and described within the present disclosure. Further embodiments are contemplated and described by the disclosure of the detailed description, drawings (if any), and claims.

In one aspect, the present disclosure relates to a composition having an amide chemical compound derived from amino acids, where the composition has a chemical structure of Formula (1):

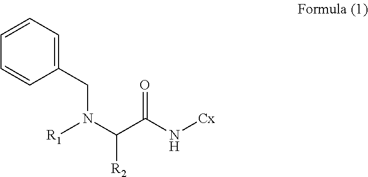

wherein:
R1 comprises Ph-CH2-, H;
R2 comprises Ph-, CH3-; and
Cx comprises alkyl or isoalkyl groups having between 10 and 18 carbon atoms, and

wherein the composition has corrosion inhibition properties in sweet and/or sour corrosive environments found in oil refinery streams.

In another aspect, the present disclosure relates to a binary combination of two compositions of Formula (1) at different molar ratios of chemical compounds with corrosion inhibition properties, wherein the molar ratios between the two chemical compounds are characterized by having molar percentage ratios of 10:90 to 90:10 in a binary mixture. In various embodiments, the two compositions are dosed into a corrosive medium at a concentration of between 5 and 100 ppm. In various embodiments, the corrosion inhibition properties of the binary combination operate up to 60° C.

In another aspect, the present disclosure relates to a method of inhibiting corrosion in sweet and/or sour corrosive environments found in oil refinery streams, the method comprising: using a composition of Formula (1) of the present disclosure to inhibit corrosion in sweet and/or sour corrosive environments found in oil refinery streams.

In another aspect, the present disclosure relates to a composition having an amide chemical compound derived from benzaldehydes, the composition having a chemical structure of Formula (2):

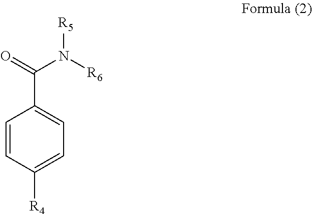

wherein:
R4 comprises H, —OH or —OCH₃;
R5 comprises H, or short alkyl chains of the type —CH₃, —C₂H₅; and
R6 comprises a saturated or unsaturated hydrocarbon chain of a hydrophobic nature containing 2 to 18 carbon atoms as: —CH₂—CH₃, —CH₂—(CH₂)₂—CH₃, —CH₂—(CH₂)₄—CH₃, —CH₂—(CH₂)₆—CH₃, —CH₂—(CH₂)₈—CH₃, —CH₂—(CH₂)₁₀—CH₃, —CH₂—(CH₂)₁₂—CH₃, —CH₂—(CH₂)₁₄—CH₃, —CH₂—(CH₂)₁₆—CH₃, —CH₂—(CH₂)₆—CH═CH—(CH₂)₈—CH₃, or —CH₂—CH₂—OH, and

wherein said composition has corrosion inhibition properties in sweet and/or sour corrosive environments found in oil refinery streams.

In another aspect, the present disclosure relates to a binary combination of two compositions of Formula (2) at different molar ratios of chemical compounds with corrosion inhibition properties, wherein the molar ratios between the two chemical compounds are characterized by having molar percentage ratios of 10:90 to 90:10 in a binary mixture. In various embodiments, the two compositions are dosed into a corrosive medium at a concentration of between 5 and 100 ppm. In various embodiments, the corrosion inhibition properties of the binary combination operate up to 60° C.

In another aspect, the present disclosure relates to a method of inhibiting corrosion in sweet and/or sour corrosive environments found in oil refinery streams, the method comprising: using a composition of Formula (2) of the present disclosure to inhibit corrosion in sweet and/or sour corrosive environments found in oil refinery streams.

In another aspect, the present disclosure relates to a binary combination of a first and second composition at different molar ratios of a corresponding first and second chemical compound with corrosion-inhibiting properties, wherein the molar ratios between the two chemical compounds are characterized by having percentage molar ratios of 10:90 to 90:10 in a binary mixture, wherein the first composition comprises a first chemical compound structure of Formula (1) and the second composition comprises a second chemical compound structure of Formula (2), as follows:

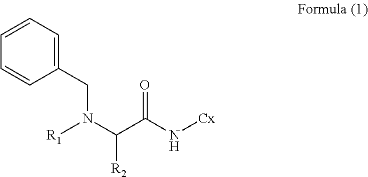

wherein:
R1 comprises Ph-CH2-, H;
R2 comprises Ph-, CH3-; and
Cx comprises alkyl or isoalkyl groups having between 10 and 18 carbon atoms; and

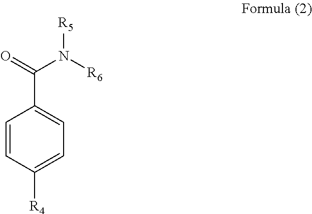

wherein:
R4 comprises H, —OH or —OCH₃;
R5 comprises H, or short alkyl chains of the type —CH₃, —C₂H₅; and
R6 comprises a saturated or unsaturated hydrocarbon chain of a hydrophobic nature containing 2 to 18 carbon atoms as: —CH₂—CH₃, —CH₂—(CH₂)₂—CH₃, —CH₂—(CH₂)₄—CH₃, —CH₂—(CH₂)₆—CH₃, —CH₂—(CH₂)₈—CH₃, —CH₂—(CH₂)₁₀—CH₃, —CH₂—(CH₂)₁₂—CH₃, —CH₂—(CH₂)₁₄—CH₃, —CH₂—(CH₂)₁₆—CH₃, —CH₂—(CH₂)₆—CH═CH—(CH₂)₈—CH₃, or —CH₂—CH₂—OH, and

wherein said binary combination has corrosion inhibition properties in sweet and/or sour corrosive environments found in oil refinery streams.

In various embodiments, the corrosion inhibition properties of the binary combination operate up to 60° C.

In another aspect, the present disclosure relates to a method of inhibiting corrosion in sweet and/or sour corrosive environments found in oil refinery streams, the method comprising: using a binary composition having compositions of Formula (1) and Formula (2) of the present disclosure to inhibit corrosion in sweet and/or sour corrosive environments found in oil refinery streams.

The foregoing and other objectives of the present disclosure will be set forth more clearly and in detail in the following disclosure

### DETAILED DESCRIPTION

The present disclosure relates to synthesizing chemical compounds derived from amides to function as corrosion inhibitors. It also relates to combinations of chemical compounds at different molar ratios, which belong to the chemical family of amides derived from amino acids and benzaldehydes. The criteria for designing combinations with different compositions of chemical compounds are based on their response to the corrosion phenomenon and synergy generated by compatible chemical compounds, i.e. the chemical functionality inherent in each family of compounds is exploited.

The first family of amides corresponds to those derived from the amino acids alanine (A) or phenylalanine (FA) and are depicted in structure (1), where R1 can be Ph-CH2-, H, R2 can be Ph-, CH3-, and Cx. can be alkyl or isoalkyl groups between 10 and 18 carbon atoms, see formula (1):

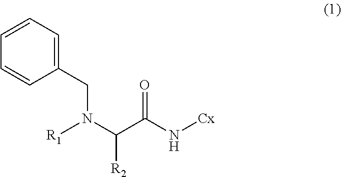

The second family of compounds in this disclosure corresponds to that of amides derived from benzaldehydes (B), also known as benzamides, and are represented by chemical structure (2), where R4 can be H, —OH, or —OCH3, R5 can be H or short alkyl chains of the type —CH3, —C2H5, and R6 can be a saturated or unsaturated hydrocarbon chain with hydrophobic nature containing 2 to 18 carbon atoms, such as —CH2-CH3, —CH2-(CH2)2-CH3, —CH2-(CH2)4-CH3, —CH2-(CH2)6-CH3, —CH2-(CH2)8-CH3, —CH2-(CH2)10-CH3, —CH2-(CH2)12-CH3, —CH2-(CH2)14-CH3, —CH2-(CH2)16-CH3, —CH2-(CH2)6-CH═CH—(CH2)8-CH3; it can also be —CH2-CH2-OH, see formula (2):

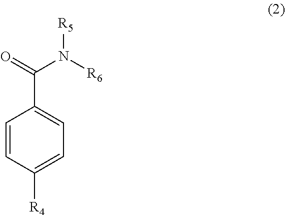

The chemical compounds in structures (1) and (2), which act as corrosion inhibitors, were added to corrosive media in solvents such as water and isopropanol, at concentrations up to 100 ppm and at temperatures up to 60° C., which is the maximum temperature reached by the corrosive medium. The corrosion inhibition evaluation was carried out using carbon steel and Admiralty alloys in two corrosive media, which were characterized as a sour medium and a sweet medium as defined by NACE-1D-182 and ASTM D1141 standards.

The present disclosure also refers to combinations of chemical compounds, which act as corrosion inhibitors, at different molar ratios. The molar ratios involve chemical compounds from the amide family in binary combinations between chemical compounds from the same family, i.e., between amides derived from amino acids (structure 1) or between amides derived from benzaldehydes (structure 2) and, from different families, i.e., between amides derived from amino acids (structure 1) and amides derived from benzaldehydes (structure 2). The molar ratios between two chemical compounds are characterized by having molar ratios ranging from 10:90 to 90:10 in the binary mixture, either between chemical compounds from the same family or between chemical compounds from different families.

Binary mixtures that act as corrosion inhibitors can be dissolved in water, isopropanol, xylene, etc. at concentrations up to 100 ppm. Binary solutions should not form a double phase or cause chemical reactions between the two components. After checking their stability for 48 h, binary mixtures of chemical compounds for inhibiting corrosion can be incorporated into the corrosive medium at temperatures up to 60° C. The evaluation of corrosion inhibition was carried out using steel and Admiralty alloys in two corrosive media, which were characterized as a sour medium and a sweet medium as defined by NACE-1D-182 and ASTM D1141 standards.

The chemical compounds and their binary combinations, at different molar ratios, which are the subject of the present disclosure, are useful for controlling internal corrosion in petroleum refining streams, in which the associated water content has a concentration of inorganic salts (i.e., chlorides, sulfates, and carbonates, among others) ranging from 300 to 7,800 ppm, where H₂S and/or CO₂ are present as dissolved gases.

### REFERENCES

[1] I. A. W. Ma, Sh. Ammar, S. S. A. Kumar, K. Ramesh, y S. Ramesh, «A concise review on corrosion inhibitors: types, mechanisms and electrochemical evaluation studies», J. Coat. Technol. Res., vol. 19, no. 1, pp. 241-268, ene. 2022, doi: 10.1007/s11998-021-00547-0.
[2] J. Mendoza y J. Genesca, Más Allá de la Herrumbre: la lucha contra la corrosión. 1989.
[3] G. Palanisamy, «Corrosion Inhibitors», 2019. doi: 10.5772/intechopen.80542.
[4] L. Hamadi, S. Mansouri, K. Oulmi, y A. Kareche, «The use of amino acids as corrosion inhibitors for metals: A review», Egypt. J. Pet., vol. 27, no. 4, pp. 1157-1165, dic. 2018, doi: 10.1016/j.ejpe.2018.04.004.
[5] V. G. DÁVILA, «Compuesto estabilizado eliminador e inhibidor de incrustaciones en tuberías», WO2012158009A1, 22 de noviembre de 2012 Accedido: 20 de febrero de 2024. [En línea]. Disponible en: https://patents.google.com/patent/WO2012158009A1/es
[6] D. J. Kalota, Y. Chou, T. K. Hirzel, D. C. Silverman, J. S. Tou, y W. R. Cho, «Novel water soluble metal working fluids», WO1998008919A3, 28 de octubre de 1999 Accedido: 20 de febrero de 2024. [En línea]. Disponible en: https://patents.google.com/patent/WO1998008919A3/en
[7] K. F. Khaled, «Corrosion control of copper in nitric acid solutions using some amino acids-A combined experimental and theoretical study», Corros. Sci., vol. 52, no. 10, pp. 3225-3234, oct. 2010, doi: 10.1016/j.corsci.2010.05.039.
[8] M. M. Kabanda, I. B. Obot, y E. E. Ebenso, «Computational Study of Some Amino Acid Derivatives as Potential Corrosion Inhibitors for Different Metal Surfaces and in Different Media», Int. J. Electrochem. Sci., vol. 8, no. 8, pp. 10839-10850, ago. 2013, doi: 10.1016/S1452-3981 (23) 13152-X.
[9] M. B. Petrović Mihajlović y M. M. Antonijević, «Copper Corrosion Inhibitors. Period 2008-2014. A Review», Int. J. Electrochem. Sci., vol. 10, no. 2, pp. 1027-1053, February 2015, doi: 10.1016/S1452-3981 (23) 05053-8.
[10] Y. Zhang, S. Zhang, B. Tan, L. Guo, y H. Li, «Solvothermal synthesis of functionalized carbon dots from amino acid as an eco-friendly corrosion inhibitor for copper in sulfuric acid solution», J. Colloid Interface Sci., vol. 604, pp. 1-14, dic. 2021, doi: 10.1016/j.jcis.2021.07.034.
[11] B. El Ibrahimi, A. Jmiai, L. Bazzi, y S. El Issami, «Amino acids and their derivatives as corrosion inhibitors for metals and alloys», Arab. J. Chem., vol. 13, no. 1, pp. 740-771, ene. 2020, doi: 10.1016/j.arabjc.2017.07.013.
[12] B. El Ibrahimi, L. Bazzi, y S. El Issami, «The role of pH in corrosion inhibition of tin using the proline amino acid: theoretical and experimental investigations», RSC Adv., vol. 10, no. 50, pp. 29696-29704, 2020, doi: 10.1039/D0RA04333H.
[13] M. A. Amin, K. F. Khaled, Q. Mohsen, y H. A. Arida, «A study of the inhibition of iron corrosion in HCl solutions by some amino acids», Corros. Sci., vol. 52, no. 5, pp. 1684-1695, may 2010, doi: 10.1016/j.corsci.2010.01.019.
[14] N. O. Eddy, «Experimental and theoretical studies on some amino acids and their potential activity as inhibitors for the corrosion of mild steel, part 2», J. Adv. Res., vol. 2, no. 1, pp. 35-47, ene. 2011, doi: 10.1016/j.jare.2010.08.005.
[15] J. Fu, S. Li, Y. Wang, L. Cao, y L. Lu, «Computational and electrochemical studies of some amino acid compounds as corrosion inhibitors for mild steel in hydrochloric acid solution», J. Mater. Sci., vol. 45, no. 22, pp. 6255-6265, November 2010, doi: 10.1007/s10853-010-4720-0.
[16] G. Gece y S. Bilgiç, «A theoretical study on the inhibition efficiencies of some amino acids as corrosion inhibitors of nickel», Corros. Sci., vol. 52, no. 10, pp. 3435-3443, October 2010, doi: 10.1016/j.corsci.2010.06.015.
[17] S. Kaya, B. Tüzün, C. Kaya, y I. B. Obot, «Determination of corrosion inhibition effects of amino acids: Quantum chemical and molecular dynamic simulation study», J. Taiwan Inst. Chem. Eng., vol. 58, pp. 528-535, ene. 2016, doi: 10.1016/j.jtice.2015.06.009.
[18] A. Kasprzhitskii, G. Lazorenko, T. Nazdracheva, y V. Yavna, «Comparative Computational Study of L-Amino Acids as Green Corrosion Inhibitors for Mild Steel», Computation, vol. 9, no. 1, p. 1, dic. 2020, doi: 10.3390/computation9010001.
[19] J. Frau y D. Glossman-Mitnik, «Conceptual DFT Descriptors of Amino Acids with Potential Corrosion Inhibition Properties Calculated with the Latest Minnesota Density Functionals», Front. Chem., vol. 5, March 2017, doi: 10.3389/fchem.2017.00016.
[20] N. O. Eddy, «Part 3. Theoretical study on some amino acids and their potential activity as corrosion inhibitors for mild steel in HCl», Mol. Simul., vol. 36, no. 5, pp. 354-363, abr. 2010, doi: 10.1080/08927020903483270.
[21] S. Pour-Ali, R. Tavangar, y S. Hejazi, «Comprehensive assessment of some I-amino acids as eco-friendly corrosion inhibitors for mild steel in HCl: Insights from experimental and theoretical studies», J. Phys. Chem. Solids, vol. 181, p. 111550, October 2023, doi: 10.1016/j.jpcs.2023.111550.
[22] Q. Deng et al., «Novel triazolyl bis-amino acid derivatives readily synthesized via click chemistry as potential corrosion inhibitors for mild steel in HCl», Corros. Sci., vol. 57, pp. 220-227, abr. 2012, doi: 10.1016/j.corsci.2011.12.014.
[23] E. Li, S. Liu, F. Luo, y P. Yao, «Amino acid imidazole ionic liquids as green corrosion inhibitors for mild steel in neutral media: Synthesis, electrochemistry, surface analysis and theoretical calculations», J. Electroanal. Chem., vol. 944, p. 117650, September 2023, doi: 10.1016/j.jelechem.2023.117650.
[24] V. Srivastava et al., «Amino acid based imidazolium zwitterions as novel and green corrosion inhibitors for mild steel: Experimental, DFT and MD studies», J. Mol. Liq., vol. 244, pp. 340-352, October 2017, doi: 10.1016/j.molliq.2017.08.049.
[25] H. M. Abd El-Lateef, M. Ismael, y I. M. A. Mohamed, «Novel Schiff base amino acid as corrosion inhibitors for carbon steel in CO2-saturated 3.5% NaCl solution: experimental and computational study», vol. 33, no. 1-2, pp. 77-97, 2015, doi: 10.1515/corrrev-2014-0059.
[26] D. S. Chauhan, M. A. Quraishi, V. Srivastava, J. Haque, y B. E. ibrahimi, «Virgin and chemically functionalized amino acids as green corrosion inhibitors: Influence of molecular structure through experimental and in silico studies», J. Mol. Struct., vol. 1226, p. 129259, February 2021, doi: 10.1016/j.molstruc.2020.129259.
[27] A. Fawzy, M. Abdallah, I. A. Zaafarany, S. A. Ahmed, y I. I. Althagafi, «Thermodynamic, kinetic and mechanistic approach to the corrosion inhibition of carbon steel by new synthesized amino acids-based surfactants as green inhibitors in neutral and alkaline aqueous media», J. Mol. Liq., vol. 265, pp. 276-291, September 2018, doi: 10.1016/j.molliq.2018.05.140.
[28] V. G. Febles, «Compuestos base aminoacidos con propiedades de inhibicion a la corrosion en medios acidos», MXPA04011376A, 18 de mayo de 2006 Accedido: 20 de febrero de 2024. [En línea]. Disponible en: https://patents.google.com/patent/MXPA04011376A/en?oq=MXPA04011376A
[29] M. Yeganeh, I. Khosravi-Bigdeli, M. Eskandari, y S. R. Alavi Zaree, «Corrosion Inhibition of I-Methionine Amino Acid as a Green Corrosion Inhibitor for Stainless Steel in the H2SO4 Solution», J. Mater. Eng. Perform., vol. 29, no. 6, pp. 3983-3994, jun. 2020, doi: 10.1007/s11665-020-04890-y.
[30] Q. H. Zhang et al., «Two amino acid derivatives as high efficient green inhibitors for the corrosion of carbon steel in CO2-saturated formation water», Corros. Sci., vol. 189, p. 109596, ago. 2021, doi: 10.1016/j.corsci.2021.109596.
[31] A. M. Al-Sabagh, N. M. Nasser, O. E. El-Azabawy, y A. E. E.-Tabey, «Corrosion inhibition behavior of new synthesized nonionic surfactants based on amino acid on carbon steel in acid media», J. Mol. Liq., vol. 219, pp. 1078-1088, July 2016, doi: 10.1016/j.molliq.2016.03.048.
[32] R. Aslam, M. Mobin, Huda, I. B. Obot, y A. H. Alamri, «Ionic liquids derived from α-amino acid ester salts as potent green corrosion inhibitors for mild steel in 1M HCl», J. Mol. Liq., vol. 318, p. 113982, November 2020, doi: 10.1016/j.molliq.2020.113982.
[33] M. Yadav, L. Gope, y T. K. Sarkar, «Synthesized amino acid compounds as eco-friendly corrosion inhibitors for mild steel in hydrochloric acid solution: electrochemical and quantum studies», Res. Chem. Intermed., vol. 42, no. 3, pp. 2641-2660, mar. 2016, doi: 10.1007/s11164-015-2172-5.
[34] M. Yadav, T. K. Sarkar, y T. Purkait, «Amino acid compounds as eco-friendly corrosion inhibitor for N80 steel in HCl solution: Electrochemical and theoretical approaches», J. Mol. Liq., vol. 212, pp. 731-738, dic. 2015, doi: 10.1016/j.molliq.2015.10.021.
[35] GUADALUPE GUZMAN PRUNEDA, NOE RODRIGUEZ SEVILLA, y JOAQUIN EGUIA-LIZ MARQUEZ, «COMPOSICION MEJORADA INHIBIDORA DE LA CORROSION CAUSADA POR ACIDOS NAFTENICOS», MXPA/a/1999/006324 Accedido: 20 febrero de 2024. de [En línea]. Disponible en: https://patentscope.wipo.int/search/es/detail.jsf?docId=MX63484&_cid=P21-LSVARP-72935-7
[36] ANDRES NOE RODRIGUEZ SEVILLA, GUADALUPE GUZMAN PRUNEDA, y JOAQUIN CRUZ EGUIA LIS MARQUEZ, «COMPOSICION INHIBIDORA DE LA CORROSION PARA UNIDADES ENDULZADORAS DE CON GAS ALCANOLAMINAS», MXPA/a/2000/012283 Accedido: 21 de febrero de 2024. [En línea]. Disponible en: https://patentscope.wipo.int/search/es/detail.jsf?docId=MX80529&_cid=P21-LSVPSW-90731-1
[37] ANDRES NOE RODRIGUEZ SEVILLA, GUADALUPE GUZMAN PRUNEDA, y JOAQUIN EGUIA LIS MARQUEZ.*, «COMPOSICION MEJORADA INHIBIDORA DE LA CORROSION Y EL AMPOLLAMIENTO POR HIDROGENO PARA UNIDADES ENDULZADORAS DE GAS CON ALCANOLAMINAS», MXPA/a/2000/010389, 16 de agosto de 2022 Accedido: 21 de febrero de 2024. [En línea]. Disponible en: https://patentscope.wipo.int/search/es/detail.jsf?docId=MX78710&_cid=P21-LSVPX8-92610-1
[38] ARQUÍMEDES ESTRADA MARTÍNEZ, NATALYA VICTOROVNA LIKHANOVA, OCTAVIO OLIVARES XOMETL, VICENTE GARIBAY FEBLES, y JESÚS MARÍN CRUZ, «COMPUESTOS BASE AMINOÁCIDOS CON PROPIEDADES DE INHIBICIÓN A LA CORROSIÓN EN MEDIOSÁCIDOS» Accedido: 21 de febrero de 2024. [En línea]. Disponible en: https://patentscope.wipo.int/search/es/detail.jsf?docId=MX128796&_cid=P21-LSVQ0Z-94358-1
[39] HEINRICH, Timo, ZORGDRAGER, Jan, PAHL, Axel, LUITJENS, Bernd-Martin, FINNER, Emil, y VERVEER, Pieter C., «MESILATO DE4-(4-TRANS-HIDROXICICLOHEXIL) AMINO-2-FENIL-7H-PIRROLO[2,3D]PIRIMIDINA Y SUS FORMAS POLIMORFICAS», MXPA/a/2005/011348, 20 de enero de 2006 Accedido: 21 febrero de 2024. de [Er línea]. Disponible en: https://patentscope.wipo.int/search/es/detail.jsf?docId=MX141041&_cid=P21-LSVQ5D-96718-1
[40] ARQUÍMEDES ESTRADA MARTÍNEZ, JESÚS MARÍN CRUZ, JOSÉ LUIS RODOLFO BENÍTEZ AGUILAR, GABRIELA ESPINOSA SANTAMARÍA.*, LUIS MANUEL QUEJ AKE, y ANGEL DÍAZ PORRAS, «INHIBIDORES DE CORROSION PARA DUCTOS QUE TRANSPORTAN MEDIOS AMARGOS PARA PROTEGER DIFERENTES TIPOS DE METALES.», MX360194, 24 de octubre de 2014 Accedido: 21 de febrero de 2024. [En línea]. Disponible en: https://patentscope.wipo.int/search/es/detail.jsf;jsessionid=0F94A38AE90A8DEA8C5DBBFDAAE00107.wapp2nA?docId=MX131140577&_cid=P20-LO61UC-88232-7
[41] E. J. Acosta, P. A. Webber, y K. A. Monk, «Corrosion inhibitors containing amide surfactants for a fluid», U.S. Pat. No. 7,989,403B2, 2 de agosto de 2011 Accedido: 21 de febrero de 2024. [En línea]. Disponible en: https://patents.google.com/patent/U.S. Pat. No. 7,989,403B2/en
[42] [symbol] y [symbol] , «Water-soluble imidazoline amide corrosion inhibitor, preparation method thereof and using method thereof», CN101705112A, 12 de mayo de 2010 Accedido: 21 de febrero de 2024. [En línea]. Disponible en: https://patents.google.com/patent/CN101705112A/en?patents=false&oq=CN10170 5112A
[43] LAURA LEE WHITLOCK y ALLA CRABTREE, «INHIBIDORES DE LA CORROSIÓN PARA APLICACIONES EN YACIMIENTOS PETROLÍFEROS», AR113004, 15 de enero de 2020 Accedido: 21 de febrero de 2024. [En línea]. Disponible en: https://patentscope.wipo.int/search/ko/detail.jsf;jsessionid=CB5D5A5A52AE8321D 6BF1C2EDDE790AE.wapp2nB?docId=AR283232725&_cid=P21-KD857U-16437-92
[44] CLARIANT INTERNATIONAL LTD., «USO DE UNA COMPOSICIÓN QUE CONTIENE AGENTES TENSIOACTIVOS BIODEGRADABLES DE AMIDA DE AZÚCAR EN COMBINACIÓN CON AL MENOS UN SINERGISTA A BASE DE AZUFRE PARA LA INHIBICIÓN DE LA CORROSIÓN», AR110296, 13 de marzo de 2019 Accedido: 21 de febrero de 2024. [En línea]. Disponible en: https://patentscope.wipo.int/search/es/detail.jsf?docId=AR240384038&_cid=P21-LSVQT0-06915-1
[45] A. P. Plensa y L. L. Salvatella, «Inhibidor de corrosion para acidos», ES2273581A1, 1 de mayo de 2007 Accedido: 21 de febrero de 2024. [En línea]. Disponible en: https://patents.google.com/patent/ES2273581A1/es?patents=false

### EXAMPLES

Examples are given of the synthesis of basic structures belonging to the families that make up the compositions of corrosion inhibitors and examples of products with binary compositions, as well as the evaluation of the corrosion inhibition efficiency of the products and individual components.

### Example 1

### Preparation of Dodecylamide from N-benzyl-2-amino-3-phenylpropanoic Acid (B-FA-C12)

The synthesis was carried out at three stages:

### Stage 1: Synthesis of methyl 2-amino-3-phenylpropanoate Hydrochloride

To a 250-mL-round-bottom flask equipped with a stirring system, a calcium chloride trap, and a liquid dropper, 100 mL of methanol and 19.49 g (118 mmol) of L-phenylalanine (MW 165.19 g/mol) were added. Subsequently, 11.20 mL (154 mmol) of thionyl chloride (MW 118.97 g/mol, 1.64 g/cm³) were incorporated dropwise; the formed mixture was kept at 65° C. and stirred for 5 h. At the end of the reaction, the solvent with excess thionyl chloride was evaporated under vacuum. The crude product was recrystallized from absolute ethanol. The compound obtained in the form of white crystals was dried in a vacuum oven at 70° C., yielding 24 g (94% yield) of methyl 2-amino-3-phenylpropanoate hydrochloride.

¹H NMR (600 MHz, D2O) δ: 2.27 (dd, J1=48 Hz, J2=18 Hz, J3=J4=6 Hz, 2H), 3.84 (s, 3H), 4.42 (dd, J1=6 Hz, J2=5.6 Hz, 1H), 7.29-7.45 (m, 5H) ppm. ¹³C NMR (150 MHz, D20): 35.7, 53.7, 54.2, 128.2, 129.4, 129.5, 133.8, 170.0 ppm.

### Stage 2: Synthesis of methyl N-benzyl-2-amino-3-phenylpropanoate

To a 100-mL-round-bottom flask equipped with a stirring system, 60 mL of acetonitrile, 4.21 g (20 mmol) of methyl 2-amino-3-phenylpropanoate hydrochloride (MW 215.68 g/mol), obtained in step 1, 4.20 g (50 mmol) of sodium bicarbonate (MW 84.01 g/mol) and 3.76 g (22 mmol) of benzyl bromide (MW 171.04 g/mol) were added. The reaction was maintained at 75° C. for 12 h under stirring at 200 rpm. At the end of the reaction, the mixture was filtered, and the solution was evaporated, yielding an amber liquid (3.40 g). The crude product was dissolved in ethyl ether and filtered, the solvent was evaporated under vacuum, yielding 3.5 g (65% yield) of methyl N-benzyl-2-amino-3-phenylpropanoate in the form of a yellowish solid.

¹H NMR (600 MHz, CD3Cl) δ: 3.39 (q, J=6 Hz, 1H), 3.65 (dd, J1=24 Hz, J2=18 Hz, 2H), 3.71 (s, 3H), 3.81 (dd, J1=J2=18 Hz, 2H), 7.21-7.38 (m, 10H) ppm. 13C NMR (150 MHz, CD3Cl): 51.8, 52.0, 54.4, 55.8, 126.9, 127.1, 128.2, 128.3 (2C), 128.4 (2C), 128.6, 139.5, 139.8, 174.9 ppm.

### Stage 3: Synthesis of Dodecylamide from N-benzyl-2-amino-3-phenylpropanoic Acid (dB-FA-C12), Formula (3)

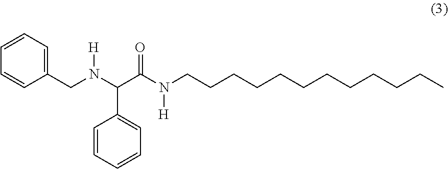 [SMILES: CCCCCCCCCCCCNC(=O)C(NCc1ccccc1)c1ccccc1]

To a 25-mL-round-bottom flask equipped with a stirring system, 2.47 g (9.17 mmol) of methyl N-benzyl-2-amino-3-phenylpropanoate (MW 269.34 g/mol), obtained in step 2, and 2.04 g (11.0 mmol) of dodecylamine (MW 185.36 g/mol) were added, keeping the mixture at 95° C. for 16 h. The excess dodecylamine was removed by vacuum distillation at 150° C., yielding 4.19 g (99% yield) of a viscous yellow liquid.

¹H NMR (600 MHz, CD3Cl) δ: 0.88 (t, J=6 Hz, 1H), 1.25-1.33 (m, 18H), 1.74 (s, 2H), 1.43-1.50 (m, 2H), 3.19-3.28 (m, 2H), 3.37-3.41 (m, 1H), 3.61-3.67 (m, 2H), 3.70-3.75 (m, 2H), 7.22-7.39 (m, 10H) ppm. ¹³C NMR (150 MHz, CD3Cl): 14.2, 22.7, 26.9, 29.3, 29.5, 29.6, 29.7 (3C), 31.9, 38.9, 42.1, 52.7, 54.4, 58.0, 126.9, 127.3, 127.9, 128.2, 128.3, 128.4, 128.5, 128.6, 139.6, 139.8, 174.6 ppm.

### Example 2

### Synthesis of Decylamide from N-benzyl-2-amino-3-phenylpropanoic Acid (B-FA-C10)

The synthesis was carried out at three stages, where stages 1 and 2 coincide with the stages in Example 1.

### Stage 3: Synthesis of Decylamide from N-benzyl-2-amino-3-phenylpropanoic Acid (B-FAC10), See Formula (4)

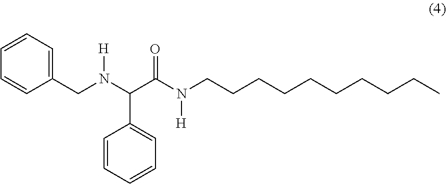 [SMILES: CCCCCCCCCCNC(=O)C(NCc1ccccc1)c1ccccc1]

To a 25-mL-round-bottom flask equipped with a stirring system, 2.47 g (9.17 mmol) of methyl N-benzyl-2-amino-3-phenylpropanoate (MW 269.34 g/mol), obtained in step 2, and 1.73 g (11.0 mmol) of decylamine (MW 157.3 g/mol) were added to the mixture, which was kept at 95° C. for 16 h. The excess decylamine was removed by vacuum distillation at 120° C., yielding 3.58 g (99% yield) of a viscous yellow liquid.

¹H NMR (600 MHz, CD3Cl) δ: 0.88 (t, J=6 Hz, 1H), 1.26-1.28 (m, 14H), 1.45-1.47 (m, 2H), 2.15 (s, 2H), 3.19-3.23 (m, 2H), 3.35-3.37 (m, 1H), 3.52-3.54 (m, 2H), 3.67-3.71 (m, 2H), 7.05-7.27 (m, 10H) ppm. ¹³C NMR (150 MHz, CD3Cl): 14.2, 23.7, 27.0, 29.3, 29.6 (2C), 29.7, 31.9, 39.0, 39.4, 52.7, 54.5, 63.3, 126.9, 127.2, 128.2, 128.5 (2C), 128.8 (2C), 129.2, 137.5, 139.3, 173.3 ppm.

### Example 3

### Synthesis of Decylamide from N-dibenzylalane (dB-A-C10)

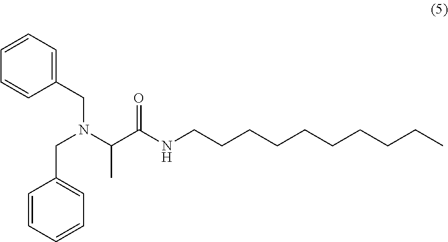 [SMILES: CCCCCCCCCCNC(=O)C(C)N(Cc1ccccc1)Cc1ccccc1]

The synthesis was carried out at three stages, where stage 1 coincides with the stages in Example 1 using L-alanine instead of L-phenylalanine.

### Stage 2: Synthesis of N-dibenzylalanyl Methyl Ester

To a 100-mL-round-bottom flask equipped with a stirring system, 60 mL of acetonitrile, 5.15 g (36.90 mmol) of alanine methyl ester hydrochloride (M.W. 139.58 g/mol), 12.9 g (130 mmol) of potassium bicarbonate (MW 100.11 g/mol) and 13.3 g (77.5 mmol) of benzyl bromide (MW 171.04 g/mol) were added. The reaction was maintained at 70° C. for 16 h under stirring at 200 rpm. At the end of the reaction, the mixture was filtered, and the solution was evaporated, yielding an amber liquid. The crude product was dissolved in acetone and filtered, the solvent was evaporated under vacuum, yielding 7.0 g (67% yield) of N-dibenzylalanyl methyl ester in the form of a yellowish liquid.

¹H NMR (600 MHz, CD₃Cl) δ: 1.30 (d, J=6 Hz, 3H), 3.49 (q, J=6 Hz, 1H), 3.62 (dd, J₁=24 Hz, J₂=18 Hz, 2H), 3.69 (s, 3H), 3.81 (dd, J₁=J₂=18 Hz, 2H), 7.18-7.38 (m, 10H) ppm. ¹³C NMR (150 MHz, CD₃Cl): 14.9, 51.1, 54.3 (2C), 56.0, 126.9 (2C), 128.2 (4C), 128.6 (4C), 139.8 (2C), 174.1 ppm.

### Stage 3: Synthesis of decylamide-N-dibenzylamine (dB-A-C10)

To a 25-mL-round-bottom flask equipped with a stirring system, 2.60 g (9.17 mmol) of N-dibenzylalanyl methyl ester (MW 283.73 g/mol), obtained in step 2, and 1.73 g (11.0 mmol) of dodecylamine (MW 157.3 g/mol) were added, keeping the mixture at 95° C. for 16 h. The excess dodecylamine was removed by vacuum distillation at 120° C., yielding 3.60 g (96% yield) of a viscous yellow liquid.

¹H NMR (600 MHz, CD₃Cl) δ: 0.89 (t, J=6 Hz, 3H), 1.20-1.26 (m, 14H), 1.42-1.44 (m, 2H), 3.14-3.20 (m, 2H), 3.43-3.47 (m, 1H), 3.56-3.58 (m, 2H), 3.65 (s, 3H), 3.75-3.77 (m, 2H), 7.13-7.32 (m, 10H) ppm. ¹³C NMR (150 MHz, CD₃Cl): 15.7, 21.5, 24.3, 28.5, 30.9 (2C), 31.1, 31.2, 31.3, 33.5, 40.5, 54.2 (2C), 56.0, 59.5, 128.8 (2C), 129.5 (4C), 130.1 (4C), 141.3 (2C), 176.2 ppm.

### Example 4

### Synthesis of N-octyl-benzamide

### One-Step Synthesis:

In a thermal condensation system consisting of a 250-mL-round-bottom flask equipped with a magnetic stirring, reflux, and vacuum system, 0.1 mol of benzoic acid (MW 122.12 g/mol) was added. Subsequently, 0.1 mol of octylamine (MW 129.25 g/mol) was integrated; the system was maintained at 150° C. under stirring for 24 h. At the end of the reaction, it was brought to room temperature. The obtained compound was a viscous brown liquid, achieving a yield greater than 95% of N-octylbenzamide (IC-B-2), see formula (6):

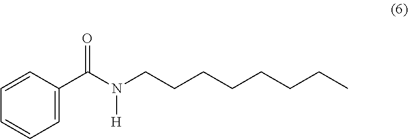 [SMILES: CCCCCCCCNC(=O)c1ccccc1]

¹H NMR (600 MHz, D₂O) δ 7.97 (d, J=7.5 Hz, 2H), 7.76 (d, J=7.4 Hz, 1H), 7.46 (t, J=7.4 Hz, 1H), 7.33 (t, J=7.6 Hz, 2H), 7.27 (s, 1H), 6.39 (s, 1H), 3.42 (dd, J=13.4, 6.8 Hz, 1H), 2.85-2.75 (m, 2H), 1.62-1.56 (m, 1H), 1.56-1.50 (m, 2H), 1.31-1.25 (m, 2H), 1.21-1.17 (m, 2H), 1.18 (dt, J=10.5, 5.0 Hz, 2H), 0.91-0.85 (m, 1H), 0.83 (t, J=7.3 Hz, 2H).

GC-MSD MW 233 g/mol, 10 long peaks: 105 999|77 292|134 258|135 206|148 120|233 104|162 100|176 82|106 78|41 50|

### Example 5

### Synthesis of 4-Hydroxi-N-ethanolbenzamide

### One-Step Synthesis:

In a thermal condensation system consisting of a 250-mL-round-bottom flask equipped with a magnetic stirring, reflux, and vacuum system, 0.1 mol of 4-hydroxybenzaldehyde (MW 168.14 g/mol) was added. Next, 50 mL of methanol were poured and stirred until completely dissolved, followed by the addition of 0.1 mol of ethanolamine (MW 68.1 g/mol). The system was maintained at 65° C. under stirring for 6 h. Finally, vacuum distillation was carried out at 70° C. until constant weight was achieved, and the reaction was brought to room temperature. The obtained compound was a brown semi-solid, with yield greater than 95% of 4-hydroxy-N-ethanolbenzamide (IC-AB-1), see formula (7):

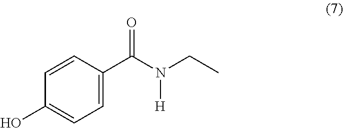

¹H NMR (600 MHz, 3>) δ 7.83-7.80 (d, J=8 Hz, 1H), 7.65 (d, J=8.6 Hz, 1H), 7.09 (s, 1H), 6.96-6.93 (m, 1H), 6.87 (d, J=8.5 Hz, 1H), 3.79-3.76 (m, 3H), 3.75-3.72 (m, 2H), 3.50, 1.25 (s, 1H).

GC-MSD MW 165 g/mol, 10 long peaks: 107 999|134 791|77 190|165 115|135 102|108 78|78 74|133 73|51 72|120 70|

### Examples 6-23

Evaluation of the corrosion inhibition properties of the basics that are the subject of this disclosure.

Specimens of 1010 carbon steel/1″×0.5″×0.010″ and Admiralty/3″×⅜″×⅙″ were weighed and placed separately in a bottle containing 180 mL of a test solution, preferably a sample from the system where the inhibitor will be used, or an aggressive brine that simulates the acidic, basic, or neutral, sour, and sweet environments at the petroleum industry; and a specific concentration of the corrosion inhibitor (CI) to be evaluated. The bottle was sealed and placed in a chamber with a 58.4 cm diameter wheel, equipped with adequate and sufficient slots for 52 samples (bottles). The chamber temperature was increased to the desired value; during heating, the wheel began to rotate at 30-35 rpm, which was maintained like that for 24 h once the temperature was reached.

At the end of the test period, the specimen was removed and washed with hexane, acetone, water, an inhibited hydrochloric acid solution, and a 5% potassium bicarbonate solution, then cleaned with soap and water using a stiff plastic brush, rinsed with deionized water, followed by rinsing with acetone and drying in an oven at 60° C. for 1 h. The specimen was allowed to reach room temperature and was then weighed. The difference in weight obtained in the specimens in experiments without (blank) and with inhibitor was used to calculate the corrosion inhibition efficiency.

The aqueous test solutions corresponded to the ASTM-D 1141 specification “Substitute Ocean Water”+600 mg/L H₂S, “Substitute Ocean Water”+CO₂ saturation; synthetic brine of ammonium bisulfide and cyanides; and typical congenital water from the oil industry.

Evaluation of the corrosion inhibition properties of the amino acid amide components, formula (1), was carried out in a sour medium at concentrations of 50, 20, and 5 ppm, which is the subject of the present disclosure; the results are shown in Table 1.

TABLE 1
Examples 6-23

| | | Concentration, | Inhibition |
|---|---|---|---|
| Example | CI | ppm | efficiency, % |
| 6. | dB-A-C10 | 50 | 90 |
| 7. | dB-A-C10 | 20 | 78 |
| 8. | dB-A-C10 | 5 | 40 |
| 9. | dB-A-C12 | 50 | 90 |
| 10. | dB-A-C12 | 20 | 81 |
| 11. | dB-A-C12 | 5 | 58 |
| 12. | dB-A-C18 | 50 | 92 |
| 13. | dB-A-C18 | 20 | 88 |
| 14. | dB-A-C18 | 5 | 78 |
| 15. | B-FA-C10 | 50 | 91 |
| 16. | B-FA-C10 | 20 | 84 |
| 17. | B-FA-C10 | 5 | 35 |
| 18. | IC-AB-2 | 50 | 92 |
| 19. | IC-AB-2 | 20 | 90 |
| 20. | IC-AB-2 | 5 | 82 |
| 21. | IC-AB-1 | 50 | 82 |
| 22. | IC-AB-1 | 20 | 76 |
| 23. | IC-AB-1 | 5 | 64 |

### Examples 24-38

Following the procedure for evaluating the components in examples 6-23, examples 24-38 were evaluated in a sweet medium and are presented in Table 2.

TABLE 2
Examples 24-38

| | | Concentration, | Inhibition |
|---|---|---|---|
| Example | CI | ppm | efficiency, % |
| 24. | dB-A-C10 | 50 | 81 |
| 25. | dB-A-C10 | 20 | 72 |
| 26. | dB-A-C10 | 5 | 51 |
| 27. | dB-A-C12 | 50 | 86 |
| 28. | dB-A-C12 | 20 | 79 |
| 29. | dB-A-C12 | 5 | 72 |
| 30. | dB-A-C18 | 50 | 61 |
| 31. | dB-A-C18 | 20 | 58 |
| 32. | dB-A-C18 | 5 | 32 |
| 33. | B-FA-C10 | 50 | 57 |
| 34. | B-FA-C10 | 20 | 62 |
| 35. | B-FA-C10 | 5 | 60 |
| 36. | IC-B-2 | 50 | 65 |
| 37. | IC-B-2 | 20 | 62 |
| 38. | IC-B-2 | 5 | 73 |

### Examples 39-47

Evaluation of the corrosion inhibition properties of benzaldehyde derivative components, formula (2), with Admiralty specimens in neutral sour medium. The results are shown in Table 3.

TABLE 3
Examples 39-47

| | | Concentration, | Inhibition |
|---|---|---|---|
| Example | CI | ppm | effciency, % |
| 39. | IC-B-1 | 5 | 86 |
| 40. | IC-AB-1 | 20 | 80 |
| 41. | IC-AB-1 | 100 | 79 |
| 42. | IC-AB-2 | 5 | 80 |
| 43. | IC-AB-2 | 20 | 87 |
| 44. | IC-AB-2 | 100 | 68 |
| 45. | IC-AB-3 | 5 | 78 |
| 46. | IC-AB-3 | 20 | 78 |
| 47. | IC-AB-3 | 100 | 70 |

### Example 48

To achieve corrosion inhibition efficiencies superior to those presented by the chemical structures individually at low dosages, compositions were designed 5 between members of two different families:

With the combination of component dB-A-C10, N-dibenzylamine decylamide, and component IC-B-2, octylbenzamide, formula (4) and formula (5), molar ratios of 0.1:1, 1:1, 1:01 were used to prepare a 40,000-ppm solution in isopropanol, as shown in Table 4.

TABLE 4
Basic amounts for compositions 0.1:1, 1:1, 1:0.1

| | % molar | | % mass | |
|---|---|---|---|---|
| Formulation | IC-AB-2 | dB-A-C10 | IC-AB-2 | dB-A-C10 |
| F1B | 10 | 90 | 5.97 | 94.03 |
| F1C | 50 | 50 | 36.35 | 63.65 |
| F1D | 90 | 10 | 83.71 | 16.29 |

### Example 49

With component dB-FA-C12, N-benzylphenylalanine dodecylamide, and component IC-B-05, octylbenzamide.

Molar ratios of 0.1:1, 1:1, 1:01 to prepare a 40,000-ppm solution in isopropanol are shown in Table 5.

TABLE 5
Basic amounts for compositions 0.1:1, 1:1, 1:0.1

| | |
|---|---|
| % molar | % mass |

| Formulation | IC-B-2 | B-FA-C12 | IC-AB-2 | B-FA-C12 |
|---|---|---|---|---|
| F2B | 10 | 90 | 5.78 | 94.22 |
| F2C | 50 | 50 | 35.57 | 64.43 |
| F2D | 90 | 10 | 83.25 | 16.75 |

### Example 50

Following the evaluation procedure in examples 6-23, the evaluation of product F1C in a sour medium is presented.

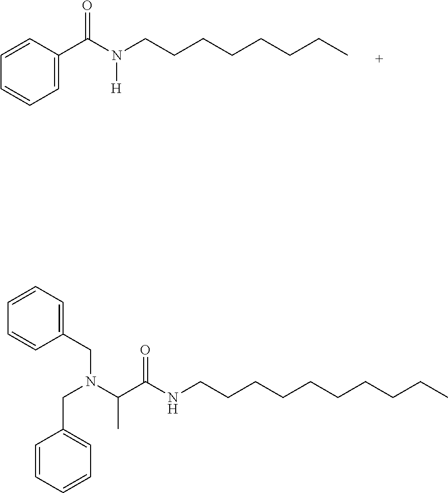 [SMILES: CCCCCCCCNC(=O)c1ccccc1 ; CCCCCCCCCCNC(=O)C(C)N(Cc1ccccc1)Cc1ccccc1]

| Binary | % efficiency in sour |
|---|---|
| formulation | acid medium |
| F1C | 90 |

### Example 51

Following the evaluation procedure for examples 23-37, the evaluation of formulation F2C for a sweet medium is presented.

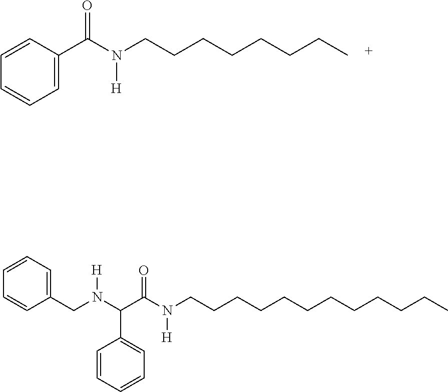 [SMILES: CCCCCCCCNC(=O)c1ccccc1 ; CCCCCCCCCCCCNC(=O)C(NCc1ccccc1)c1ccccc1]

| Binary | % efficiency in sweet |
|---|---|
| formulation | acidic environments |
| F2C | 90 |

What is claimed is:

1. A composition comprising an amide chemical compound derived from amino acids, said composition having a chemical structure of Formula (1): 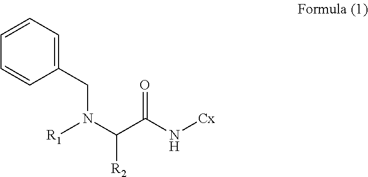
wherein:
R1 comprises Ph-CH2-, H;
R2 comprises Ph-, CH3-; and
Cx comprises alkyl or isoalkyl groups having between 10 and 18 carbon atoms, and
wherein said composition has corrosion inhibition properties in sweet and/or sour corrosive environments found in oil refinery streams.

2. The composition according to claim 1, wherein the composition is dosed into a corrosive medium at a concentration of between 5 and 100 ppm.

3. The composition according to claim 1, wherein the corrosion inhibition properties of the composition operate up to 60° C.

4. A binary combination of two compositions according to claim 1 at different molar ratios of chemical compounds with corrosion inhibition properties, wherein the molar ratios between the two chemical compounds are characterized by having molar percentage ratios of 10:90 to 90:10 in a binary mixture.

5. The binary combination according to claim 4, wherein the two compositions are dosed into a corrosive medium at a concentration of between 5 and 100 ppm.

6. The binary combination according to claim 4, wherein the corrosion inhibition properties of the binary combination operate up to 60° C.

7. A method of inhibiting corrosion in sweet and/or sour corrosive environments found in oil refinery streams, the method comprising:
using a composition according to claim 1 to inhibit corrosion in sweet and/or sour corrosive environments found in oil refinery streams.

8. The method according to claim 7, wherein the composition is dosed into a corrosive medium at a concentration of between 5 and 100 ppm.

9. The method according to claim 7, wherein the corrosion inhibition properties of the composition operate up to 60° C.

10. A composition comprising an amide chemical compound derived from benzaldehydes, said composition having a chemical structure of Formula (2): 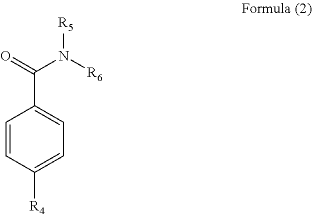
wherein:
R4 comprises H, —OH or —OCH₃;
R5 comprises H, or short alkyl chains of the type —CH₃, —C₂H₅; and
R6 comprises a saturated or unsaturated hydrocarbon chain of a hydrophobic nature containing 2 to 18 carbon atoms as: —CH₂—CH₃, —CH₂—(CH₂)₂—CH₃, —CH₂—(CH₂)₄—CH₃, —CH₂—(CH₂)₆—CH₃, —CH₂—(CH₂)₈—CH₃, —CH₂—(CH₂)₁₀—CH₃, —CH₂—(CH₂)₁₂—CH₃, —CH₂—(CH₂)₁₄—CH₃, —CH₂—(CH₂)₁₆—CH₃, —CH₂—(CH₂)₆—CH═CH—(CH₂)₈—CH₃, or —CH₂—CH₂—OH, and
wherein said composition has corrosion inhibition properties in sweet and/or sour corrosive environments found in oil refinery streams.

11. The composition according to claim 10, wherein the composition is dosed into a corrosive medium at a concentration of between 5 and 100 ppm.

12. The composition according to claim 10, wherein the corrosion inhibition properties of the composition operate up to 60° C.

13. A binary combination of two compositions according to claim 10 at different molar ratios of chemical compounds with corrosion inhibition properties, wherein the molar ratios between the two chemical compounds are characterized by having molar percentage ratios of 10:90 to 90:10 in a binary mixture.

14. The binary combination according to claim 13, wherein the two compositions are dosed into a corrosive medium at a concentration of between 5 and 100 ppm.

15. The binary combination according to claim 13, wherein the corrosion inhibition properties of the binary combination operate up to 60° C.

16. A method of inhibiting corrosion in sweet and/or sour corrosive environments found in oil refinery streams, the method comprising:
using a composition according to claim 10 to inhibit corrosion in sweet and/or sour corrosive environments found in oil refinery streams.

17. The method according to claim 16, wherein the composition is dosed into a corrosive medium at a concentration of between 5 and 100 ppm.

18. The method according to claim 16, wherein the corrosion inhibition properties of the composition operate up to 60° C.

19. A binary combination of a first and second composition at different molar ratios of a corresponding first and second chemical compound with corrosion-inhibiting properties, wherein the molar ratios between the two chemical compounds are characterized by having percentage molar ratios of 10:90 to 90:10 in a binary mixture, wherein the first composition comprises a first chemical compound structure of Formula (1) and the second composition comprises a second chemical compound structure of Formula (2), as follows: 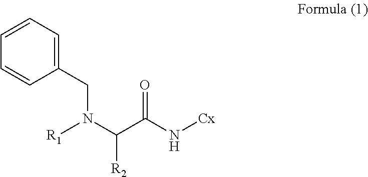
wherein:
R1 comprises Ph-CH2-, H;
R2 comprises Ph-, CH3-; and
Cx comprises alkyl or isoalkyl groups having between 10 and 18 carbon atoms; and 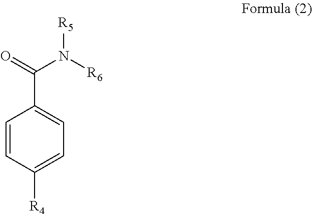
wherein:
R4 comprises H, —OH or —OCH₃;
R5 comprises H, or short alkyl chains of the type —CH₃, —C₂H₅; and
R6 comprises a saturated or unsaturated hydrocarbon chain of a hydrophobic nature containing 2 to 18 carbon atoms as: —CH₂—CH₃, —CH₂—(CH₂)₂—CH₃, —CH₂—(CH₂)₄—CH₃, —CH₂—(CH₂)₆—CH₃, —CH₂—(CH₂)₈—CH₃, —CH₂—(CH₂)₁₀—CH₃, —CH₂—(CH₂)₁₂—CH₃, —CH₂—(CH₂)₁₄—CH₃, —CH₂—(CH₂)₁₆—CH₃, —CH₂—(CH₂)₆—CH═CH—(CH₂)₈—CH₃, or —CH₂—CH₂—OH, and
wherein said binary combination has corrosion inhibition properties in sweet and/or sour corrosive environments found in oil refinery streams.

20. The binary combination according to claim 19, wherein the first and second compositions are dosed into a corrosive medium at a concentration of between 5 and 100 ppm.

21. The binary combination according to claim 19, wherein the corrosion inhibition properties of the binary combination operate up to 60° C.

22. A method of inhibiting corrosion in sweet and/or sour corrosive environments found in oil refinery streams, the method comprising:
using a binary combination according to claim 19 to inhibit corrosion in sweet and/or sour corrosive environments found in oil refinery streams.

23. The method according to claim 22, wherein the first and second compositions are dosed into a corrosive medium at a concentration of between 5 and 100 ppm.

24. The method according to claim 22, wherein the corrosion inhibition properties of the first and second compositions operate up to 60° C.
